(19) United States
(12) Patent Application Publication
(10) Pub. No.: US 2008/0222172 A1
(43) Pub. Date: Sep. 11, 2008

(54) Method and Device for Authoring a Digital Videodisc; Programme, Recording Medium and Instantiating Module for Said Method

(75) Inventor: David Chomard, Lyon (FR)

Correspondence Address: OCCHIUTI ROHLICEK & TSAO, LLP, 10 FAWCETT STREET, CAMBRIDGE, MA, 02138, US

(73) Assignee: LITTLE WORLDS STUDIO, LYON (FR)

(21) Appl. No.: 12/064,258

(22) PCT Filed: Sep. 20, 2006
(86) PCT No.: PCT/FR2006/002154

§ 371 Date: Feb. 20, 2008

(30) Foreign Application Priority Data
Sep. 21, 2005 (FR) 0509646

(51) Int. Cl. G06F 17/30

(52) U.S. Cl. 707/100; 707/E17.122

(57) ABSTRACT

This method of authoring a DVD-Video disc comprises:
a) a step (108) for creating a model for a DVD-Video structure portion, this model comprising markers of an SGML defining at least one PGC (Program Chain),
b) a step (116) of instantiation of the model during which each instanciable attribute value is automatically replaced by a given value to obtain an instance of the model, and
c) a step (122) of generation of a picture of the DVD-Video disc.

The present invention pertains to a method and device for authoring a DVD-Video disc as well as a program, a recording medium and an instantiation module for this method.

Here below in this text, the technical terms used are those defined by the DVD-Video standard and in the SGML (Standard Generalized Markup Language) and XML (Extended Markup Language) standards.

It may be recalled here that a DVD-Video structure as defined in the DVD-Video standard is an arborescent or hierarchically organized structure in which each element of the structure may comprise sub-elements, themselves comprising sub-elements and so and so forth until the smallest element constituting a termination of the arborescence. For example, the root elements of the structure of a DVD-Video disc unit are formed by a VMG (Video Manager) element and one or more VTS (Video Title Set) elements or titles.

The VMG element is itself formed by a VMGI (Video Manager Information) element, a VMGM-VOBS (Video Object Set for VGM Menu) and a saving element VMGI (BUP).

Similarly, each VTS element is formed by a VTSI (Video Title Set Information), a VTSM VOBS (Video Object Set for the VTS Menu) element, a VTSTT_VOBS (Video Object Set for Titles in VTS) element and a VTSI (BUP) saving element.

The VTSI element contains control data for the VTS element. The VTSI element is recorded in a file VTS_##_{—}0.IFO on the DVD-Video disc.

The VTSM VOBS element contains the content of all the types of menus of the VTS element. This content is recorded in a file VTS_##_{—}0.VOB on the DVD-Video disc.

The VTSTT_VOBS element contains the multimedia (audio and video) content which must be played by the DVD player. This content is recorded in files VTS_##_@.VOB.

Here, the symbol ## represents a two-digit number and the number @ represents a one-digit number.

The VOBs elements, i.e. for example the VTSM VOBS and VTSTT_VOBS elements include individual cells linked to one another by the PGC (Program Chains).

Each cell contains the audio and video resources liable to be played by a DVD reader. The resources are of four types:
video data streams encoded in the MPEG 1 or 2 format or pictures (“slideshows” in the DVD-Video standard),
audio data streams,
sub-images or sub-pictures (according to the DVD-Video standard), and
browsing data to produce the necessary interactivity with the user to browse in the DVD-Video disc.

Each PGC may contain DVD-Video code written in a programming language developed for DVD-Video discs so as to provide the interactivity necessary for the use of the DVD-Video disc. For example, this DVD-Video code enabling the definition of the action must be executed by a DVD reader in response to the pressing of a predetermined key of a remote control unit of the DVD reader. The DVD-Video code is written by means of low-level mnemonics each corresponding to a binary code executable by a DVD-Video player.

The set of files (files with extensions .IFO, .VOB and .BUP) defining the structure of the DVD-Video disc as well as the audio, video, picture and sub-picture resources intended for recording on the DVD disk to form a DVD-Video disc, are called “pictures of the DVD-Video disc”. At the lowest level, a DVD-Video picture corresponds to a binary code formed by 0s and 1s.

To avoid having to write directly in binary code, a low-level programming language comprising mnemonics representing the structure of the DVD-Video disc has been defined. These mnemonics are very close to the binary code and enable checks precisely on the binary code obtained. However, authoring a DVD-Video disc with a complex browsing structure by means of mnemonics proves to be lengthy and painstaking. Indeed, in the computer world, this amounts to programming in assembler language, for example.

To overcome this drawback, authoring methods introducing levels of instruction have been proposed. Such a method has been proposed for example in the patent application No. WO 03/094519 filed on half of Zoo Digital Group.

The abstraction layer is aimed at enabling the programmer to concentrate on the result to be obtained without being concerned with implementation in low-level language. For example, the method disclosed in WO 03/094519 enables the programmer to define components representing menus of the DVD-Video disc as well as transitions between these components. These transitions represent, for example, the possible shifts between the different menus. Furthermore, the components can be parameterized so that one parameterized component alone enables numerous examples of non-parameterized components to be represented.

During the compilation, the parameterized components and the transitions are developed so as to obtain a non-parameterized arborescent structure and this non-parameterized arborescent structure is automatically converted into a DVD-Video picture.

In the authoring methods that use an abstraction layer, the conversion of the components and transitions into a DVD-Video structure is done automatically by a compiler. This means that the programmer cannot always control the structure of the DVD-Video disc obtained with precision. For example, in certain cases, it is the compiler that automatically makes a choice, instead of the programmer, between different possible DVD-Video structures to obtain the specified desired result at the level of the abstraction layer. More specifically, given the great flexibility of the DVD-Video standard, it is possible to create DVD-Video structures that are different and yet give a same final result such as, for example, a given arborescence for browsing between different menus of a DVD-Video disc. However, depending on the DVD-Video disc prepared, a particular structure of the DVD-Video disc may prove to perform better than another one or be more compatible even if the results displayed are substantially the same.

The invention is therefore aimed at overcoming this drawback by proposing a method for authoring a DVD-Video disc to facilitate the authoring of a DVD-Video disc while at the same time enabling precise control over the structure of the DVD-Video disc.

An object of the invention therefore is an authoring method such as this comprising:

a) a step for the creation for a model of a DVD-Video structure portion, this model comprising:
markers of an SGML (Standard Generalized Markup Language) defining at least one PGC (Program Chain) and elements of this PGC, the interleaving of these markers with each other defining a hierarchically established organization of the elements of the PGC,
at least one instanciable attribute value constituted by a string of characters in place of an attribute value for a marker, this instanciable attribute value containing at least one predetermined character enabling the identification of this string of characters as being an instanciable attribute value,

b) a step of instantiating of the model during which each instanciable attribute value is automatically replaced by a given value to obtain an instance of the model, and

c) a step of generation of a picture of the DVD-Video disc capable of being read by a DVD-Video player, each instance being compiled in this step.

To facilitate the authoring of the DVD-Video disc while at the same time achieving precise control over its structure, the above method makes use of the fact that numerous portions of the structure of the DVD-Video disc may be similar to each other. The term “similar” herein designates the fact that one portion of the structure differs from another portion of the structure solely by the value of a restricted number of values of attributes.

For example, for a DVD-Video disc implementing a quiz, the portions of the structure each corresponding to a question are often similar to each other. More specifically, it often happens that the only differences between portions of structures corresponding to different questions are the following:
the video and audio resources used for each question are different from one question to another, and
the right response to be selected for each question does not always correspond to a same key of the remote control unit from one question to another.

Thus, numerous parts of a DVD-Video structure may be similar without in any way thereby being identical.

In this context, with the above method, during the step a) the programmer can create a model for the portion of the structure of the DVD-Video disc corresponding to a question. This model is a low-level model enabling it to explicitly define the organization of this structure portion as well as content of the structure portion common to each question. More specifically, the markers used to this end enable it to achieve a precise definition of a hierarchically established organization for each PGC. In particular, the markers enable it to choose the organization that it wishes to implement from among the set of possible organizations to implement the structure portion corresponding to a question. Through this, unlike in the case of prior art methods for authoring a DVD-Video disc by means of abstraction layers, the programmer can achieve precise control over the organization and content of the structure portion common to each question.

Then, during the step b), instances of the model are created. For example an instance is created for each question of the quiz. During this step b), only the given values have to be provided. In other words, the programmer does not have to define or explicitly rewrite the organization and the common content of each similar structure portion. On the contrary, the organization and the common content of each instant are automatically deduced from the model, so that the creation of different structure portions similar to one another is greatly facilitated.

The embodiments of this authoring method may include one or more of the following characteristics:
the model contains a DVD-Video code between the markers, at least one portion of this code being replaced by an instanciable variable constituted by a string of characters containing at least one predetermined character enabling the identification of this string of characters as being an instanciable variable, and between the steps b) and c), the method comprises a step of resolution of links during which the value of each instanciable variable is automatically defined as a function of the instances created;
the step a) comprises:
   an operation for the writing, by means of low-level mnemonics and values of attributes, of a DVD-Video structure portion defining one or more PGCs, and
   a step of automatic conversion of this structure portion into a DVD-Video structure model in replacing at least one attribute value by an instanciable attribute value;
during the step b), the given values are obtained automatically from a data base.

The embodiments of the elaboration method furthermore have the following advantages:
the use of instanciable variables in the DVD-Video code whose values are capable of being defined automatically during the resolution of links, accelerates the creation of the DVD-Video code of each instance,
the automatic conversion of a DVD-Video structure portion into a model accelerates the creation of this model, and
the reading of the given values during the step b) in a data base enables the instantiating step to be accelerated.

An object of the invention is also a computer program and a recording medium comprising instructions for the implementation of the above authoring method, when these instructions are executed by an electronic computer.

An object of the invention is also a device for the creation of DVD-Video disc comprising:
a module for creating a model of a DVD-Video structure portion, this module comprising:
   markers of an SGML (Standard Generalized Markup Language) defining at least one PGC (Program Chain) and elements of this PGC, the interleaving of these markers with each other defining a hierarchically established organization of the elements of the PGC,
at least one instanciable attribute value constituted by a string of characters in place of an attribute value for a marker, this instanciable attribute value containing at least one predetermined character enabling the identification of this string of characters as being an instanciable attribute value,
a module for instantiation of the created model capable of automatically replacing each instanciable attribute value of the module by a given value to obtain an instance of the model, and
a compiler capable of compiling each instance of the model to generate a picture of the DVD-Video disc readable by a DVD-Video player.

The embodiments of this device may comprise one or more of the following characteristics:
the creation module is capable of creating a model comprising a DVD-Video code between the markers, at least one portion of this code being replaced by an instanciable variable constituted by a string of characters containing at least one predetermined character enabling the identification of this string of characters as being an instanciable variable, and it comprises a module for the resolution of links capable of automatically defining the value of each instanciable variable as a function of the instances created;
the creation module comprises:
   a sub-module for writing a DVD-Video structure portion defining one or more PGCs by means of low-level mnemonics and values of attributes, and
   a conversion sub-module capable of automatically converting the DVD-Video structure portion written by means of the write module into a DVD-Video structure model in replacing at least one attribute value by an instanciable attribute value;
the instantiation module is capable of automatically obtaining the values given to the instanciable attribute values from a data base.

An object of the invention is also an instantiation module capable of being implemented in the above device.

The invention will be understood more clearly from the following description, given purely by way of an example and made with reference to the appended drawings of which:

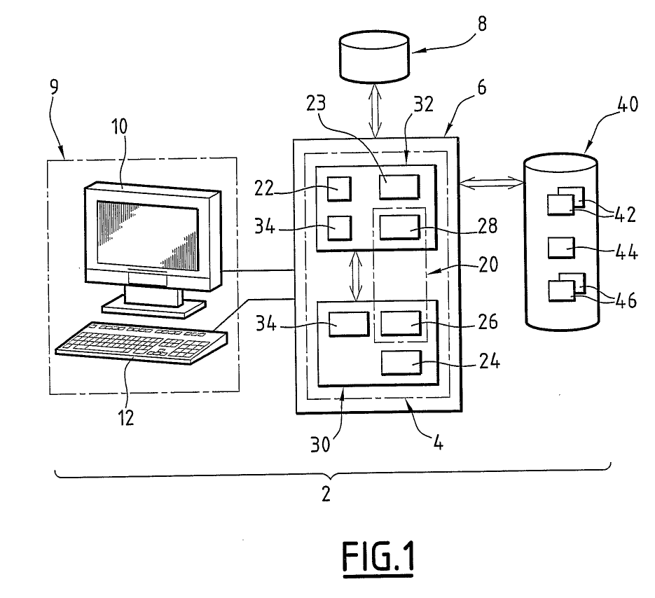

FIG. 1 is a schematic illustration of the architecture of a device for authoring a DVD-Video disc,

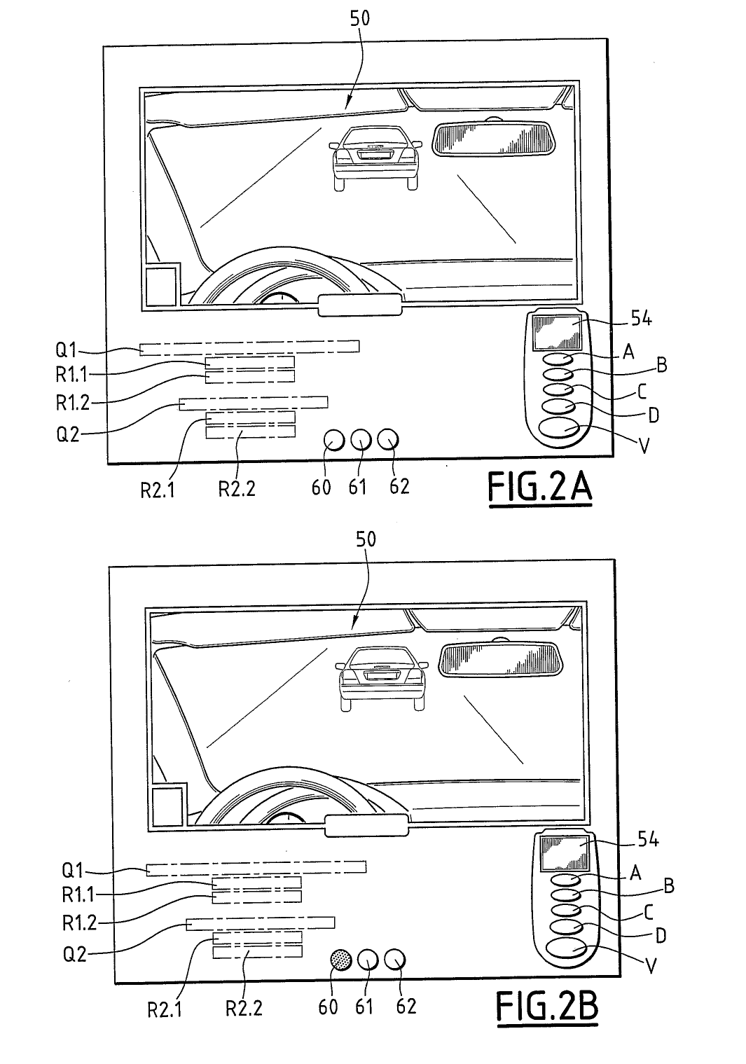

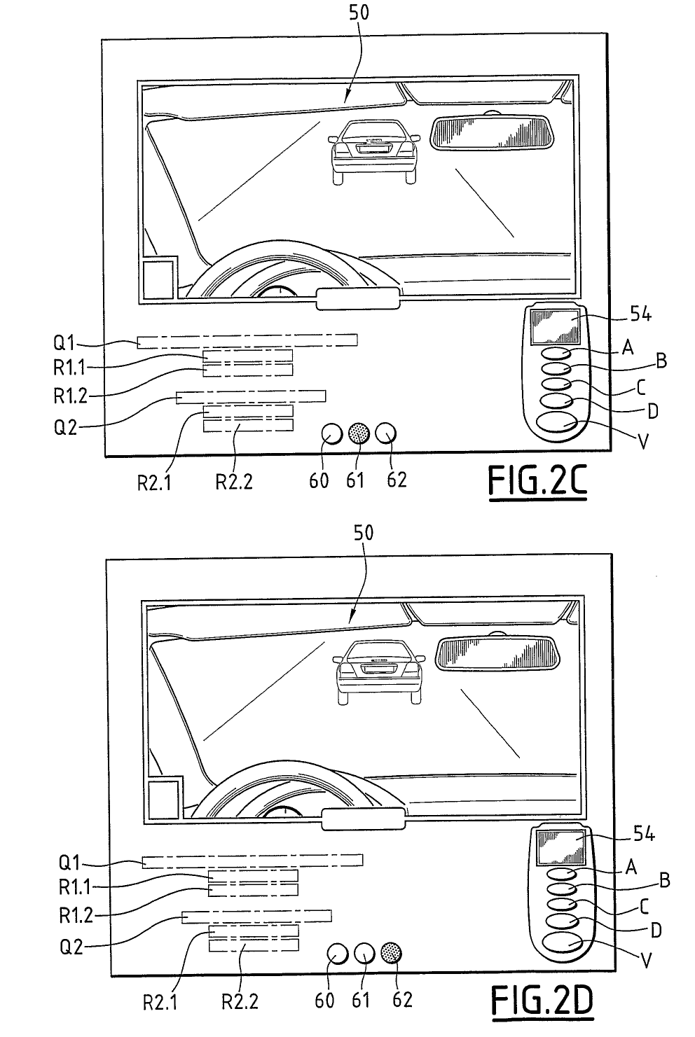

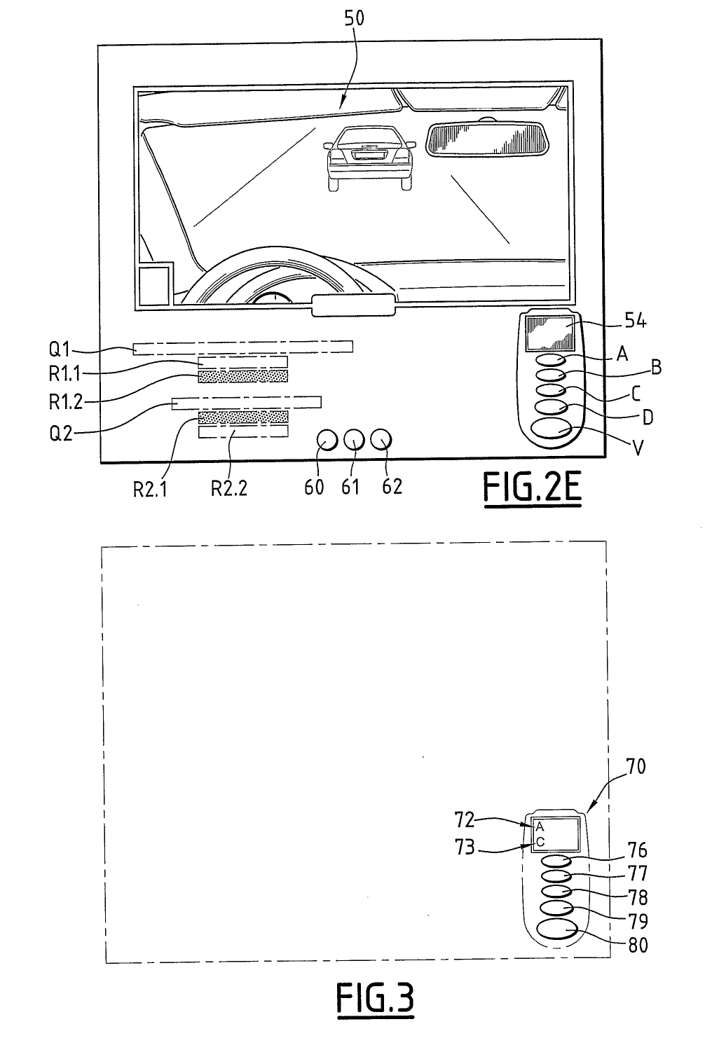

FIGS. 2A to 2E are illustrations of picture type resources used during the authoring of a DVD-Video disc using the device of FIG. 1,

FIG. 3 is an illustration of a sub-picture type resource used during the authoring of a DVD-Video disc by means of the device of FIG. 1,

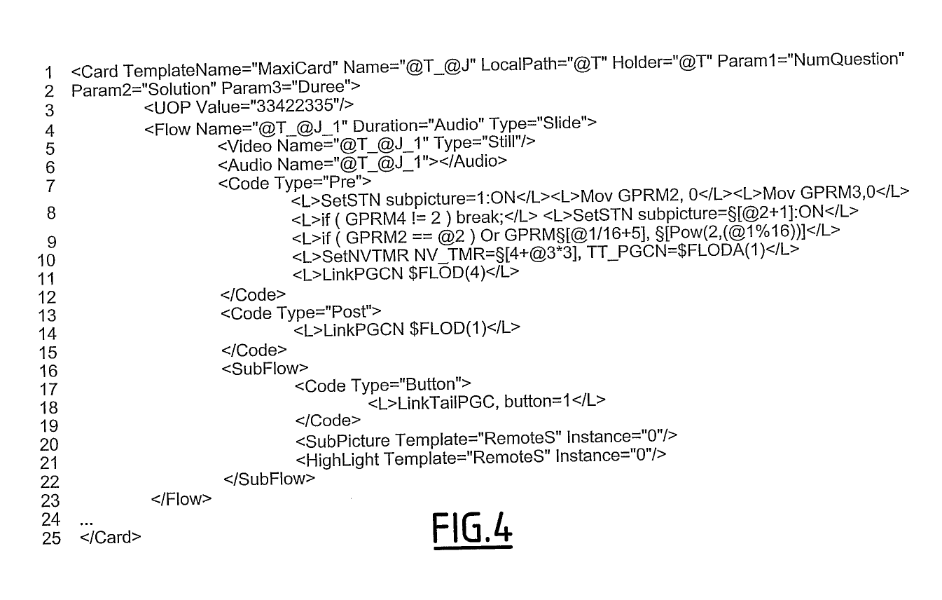

FIG. 4 is an extract of a listing of a model of a DVD-Video structure portion usable in the device of FIG. 1,

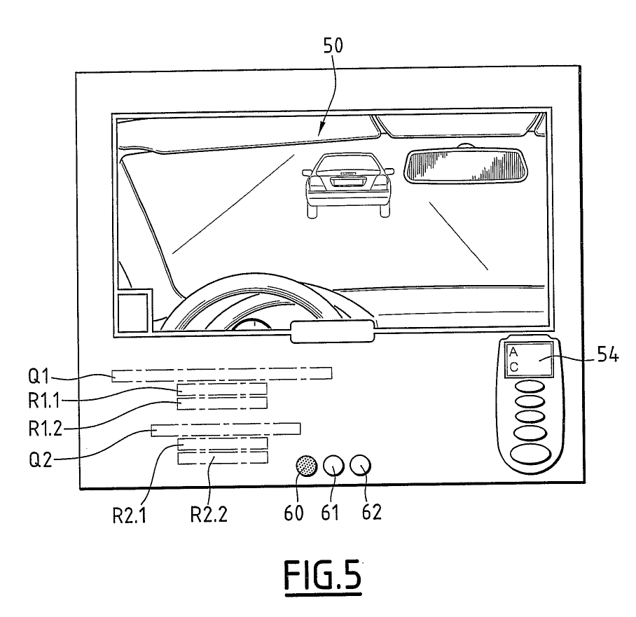

FIG. 5 is an illustration of a picture visible during the playing of a DVD-Video disc authored by means of the device of FIG. 1,

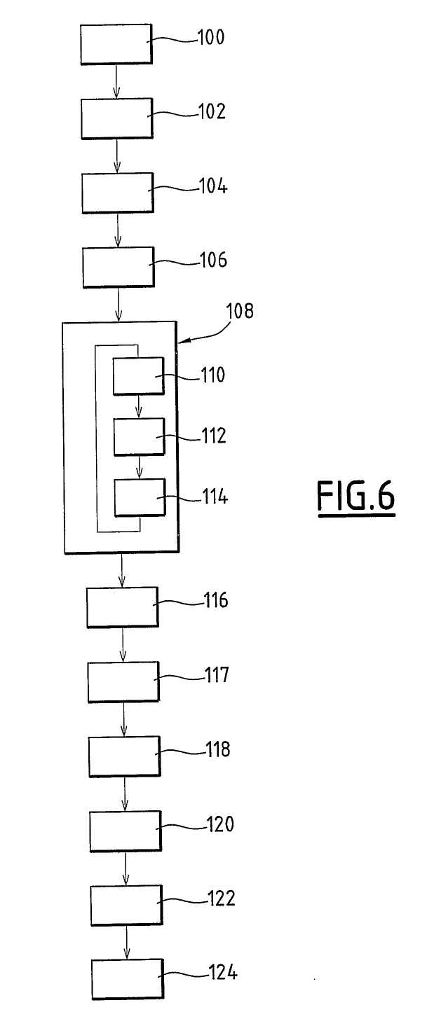

FIG. 6 is a flow chart of a method for authoring a DVD-Video disc, and

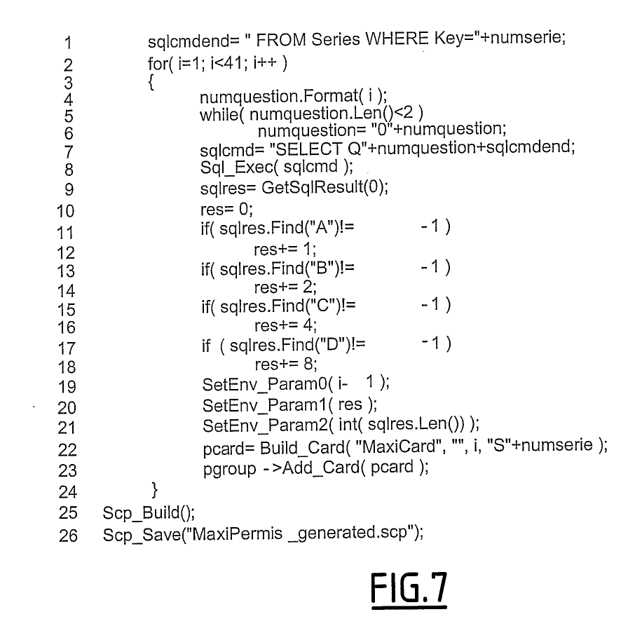

FIG. 7 is an extract of a script listing implemented in the method of FIG. 6.

FIG. 1 shows a device 2 for the authoring of a DVD-Video disc.

This device 2 comprises a program 4 for authoring a DVD-Video disc executable by an electronic computer 6.

Typically, the computer 6 is a programmable computer capable of executing instructions recorded on an information recording medium 8. To this end, the medium 8 contains instructions to execute the process of FIG. 6.

The computer 6 is attached to a man/machine interface 9 enabling the display and entry of information. The interface 8 is, for example, formed by a screen 10 and a keyboard 12.

The software program 4 comprises:
a module 20 for creating a model of a DVD-Video structure portion,
a module 22 for the instantiating of the model created by means of the module 20,
a link-resolution module 23, and
a compiler 24 capable of generating the picture of a DVD-Video disc capable of being read by a DVD-Video player, in compiling the instances generated by the module 22.

The module 20 comprises a sub-module 26 for writing the structure of a DVD-Video disc in low-level language, and a sub-module 28 for the automatic conversion of a DVD-Video structure portion written by means of the module 26 in an instanciable model by the module 22.

Compilers such as the compiler 24 and write modules such as the sub-module 26 are already known. For example, the module 24 and the sub-module 26 are those of a software program 30 commercially distributed under the brand name “Scenarist” by the firm SONIC (see www.sonic.com). The modules 22, 23 and the sub-module 28 form part of a software program 32 specifically designed to exchange information with the software program 30. To this end, the software programs 30 and 32 respectively comprise modules 34 and 36 for the export of data which they generate in a text file and for the import of data present in a text file of this kind in the software program. Here, the exported or imported text file is in the “Script” format by Scenarist.

The device 2 also comprises information storage means herein shown in the form of a memory 40 designed to contain:
video and audio resources 42 used during the authoring of the DVD-Video disc,
at least one model 44 of a DVD-Video structure portion, and
possibly, a data base 46 containing given values usable during the instantiation of a model.

FIGS. 2A to 2E each give a view of a picture forming part of the resources 42. For example, each picture is recorded in a file in the “BITMAP” format.

Each of the five pictures comprises:
the same photo 50 of a situation of the traffic code,
the text of two questions in the frames Q1 and Q2,
for the question Q1, two frames R1.1 and R1.2 and for the question Q2 also two frames R2.1 and R2.2,
a frame 54 designed to display the responses selected by the user or the responses to the questions,
four buttons of a remote control unit referenced A to D and a validation button V, and
three indicator lights 60 to 62 used to indicate the time remaining before the end of the time allocated to responding to the questions Q1 and Q2.

The frame R1.1 indicates that if the user believes that the response to the question Q1 is “yes”, the button A must be selected. The frame R1.2 indicates that the button B must be selected if the response to the question is “no”.

Similarly, the frames R2.1 and R2.2 indicate that the buttons C and D correspond respectively to a response “yes” and “no”.

The pictures of FIGS. 2A to 2D differ solely in the color of the indicator lights 60 to 62. More specifically, in the picture of FIG. 2A, none of the indicator lights 60 to 62 is on. In FIG. 2B, only the indicator light 60 is on. In FIG. 2C, only the indicator light 61 is on and in FIG. 2D only the indicator light 62 is on.

The picture of FIG. 2E is identical to that of FIG. 2A except that the correct responses to the questions Q1 and Q2, namely in this case the responses R1.2 and R2.1, are highlighted.

FIG. 3 shows a sub-picture 70 recorded as a resource 42. The sub-picture 70 is designed to be superimposed on one of the pictures of FIGS. 2B to 2D. More specifically, it comprises two characters 72 and 73 corresponding to the responses selected by the user of the DVD-Video disc. The sub-picture 70 also has five ovals 76 to 80 designed to be superimposed respectively on the buttons A to D and on the validation button. The ovals 76 to 80 are herein used to designate the user-selectable buttons as well as the currently selected button.

There presently exist sub-pictures similar to the sub-picture 70 each corresponding to one of the combinations of two possible letters chosen from the set [A; B; C; D].

Here, the resources 42 also comprise an audio resource corresponding to the reading of the questions Q1 and Q2 as well as the responses R1.1, R1.2, R2.1, and R2.2. Another video resource corresponds to the reading of the exact responses to the questions Q1 and Q2.

For each question pertaining to a situation of the traffic code, there are therefore five pictures, sub-pictures and two audio resources recorded as video and audio resources 42.

FIG. 4 represents a listing of an exemplary model defined in XML. In this listing, the numbers to the left are the line numbers.

The opening marker <Card . . . > and the closing marker </Card> designate the start and end of the definition of a model of a DVD-Video structure portion (lines 1 and 25).

The opening marker <Card . . . > comprises several attributes:
“Template name” used to indicate the name of this model,
“Name” used to indicate the name of an instance,
“LocalPath” used to indicate the access path to the resources used by the instances,
“Holder” used to designate the access part at which the instance within an arborescence must be classified,
“Param1” used to indicate the number of the question,
“Param2” used to indicate the number of the response to the question, and
“Param3” used to define the time allocated to respond to the question.

It will be noted that the values of the attributes “Name”, “LocalPath”, and “Holder” are formed by strings of characters, each comprising at least one special character, in this case the character @. The character @ is herein used to indicate that this is an instanciable attribute value designed to be replaced by a given attribute value during the instantiating of this model.

The values of the attributes “Param1”, “Param2” and “Param3” are herein respectively equal to “NumQuestion”, “Solution” and “Duration”. The three strings of characters “NumQuestion”, “Solution” and “Duration” are predetermined strings of characters used to respectively identify three instanciable attribute values: @1, @2 and @3. These strings of characters are used to give a piece of information comprehensible to the programmer on the nature of its attributes @1, @2 and @3.

The line 3 of the listing of FIG. 4 comprises the marker <UOP> as well as an attribute entitled “Value” for which the attribute value is “33422335”. The marker <UOP> is used to indicate the start of the definition of the commands that the user can execute by means of its remote control unit. The attributes value “33422335” includes no predetermined character capable of enabling the module 22 to recognize it as being an instanciable attribute value. This attribute value is therefore constant and will be identical for each of the created instances of the model. Here, the value “33422335” indicates that the user can use only the direction arrows and the validation keys of his remote control unit. This marker <UOP> is uniquely situated between the markers <Card> and </Card>. Consequently, this definition is inherited by the set of offspring elements between the markers <Card> and </Card>. For example, this definition can be applied to each PGC element defined in this model. This method of inheritance of properties can also be applied to the values of attributes. Thus, the attributes of an offspring element can inherit the value of the attribute of the parent element.

The opening markers <Flow . . . > (line 4) and closing marker </Flow> (line 23) are used to define a PGC. The attributes “Name”, “Duration” and “Type” of the marker <Flow> enable the definition respectively of the name of the PGC, its duration and its type. Here, the PGC described is designed to manage the picture of FIG. 2A.

As here above, the special character @ in the attributes value of the attribute “Name” indicates that it is an instanciable attribute value.

The attribute value “Audio” of the attribute “Duration” indicates that this PGC must last the same time as the time needed to listen to the entire audio source associated with it.

The attribute value “Slide” for the attribute “Type” indicates that the video resource here is a transparent (“SlideShow”).

Between the markers <Flow . . . > and </Flow> there are included other markers used to define the organization and the elements contained in this PGC.

At the line 5, a marker <Video> and its attributes “Name” and “Type” define the unique video resource referenced by the PGC. Here, the attribute value “@T_@J_{—}1” is identical to the name of the PGC and indicates that this is an instanciable attribute value. This value could therefore have been inherited from the parent element. The attribute value “Still” indicates that the video resource is a still picture. This attribute value is a constant value and therefore identical for each of the instances of the model.

At the line 6, the marker <Audio> and the attribute “Name” enables the audio resource used in this PGC to be referenced. More specifically, the name of the resource used here is “@T_@J_{—}1”. This is an instanciable attribute value.

The opening markers <Code> (line 7) and the closing marker </Code> (line 12) enclose, between them, the definition of a DVD-Video code. The attribute “Type” indicates whether the code must be executed before the video and audio resources are played (“Pre-command” in the DVD-Video standard), or while these video and audio resources are played or again after these audio and video resources have been played (“Post-command” in the DVD-Video standard).

The value “Pre” of the attribute “Type” indicates here that the code between the lines 7 and 12 must be executed before the resources are played.

Conversely, the value “Post” of the attribute “Type” indicates that the code between the lines 13 and 15 must be executed after the resources have been played.

The markers <L> and </L> (lines 8 to 11 and 14) enclose each DVD-Video code line. Here, the code indicated between these markers at the lines 8 to 11 and at the line 4 is written by using the mnemonics understood by the Scenarist software program. The meaning of these mnemonics will therefore not be given here since it can be found in the documentation of the Scenarist software. These mnemonics are normally identical to those defined by the DVD-Video standard.

The lines 8 to 10 contain three instanciable attribute values, respectively @1, @2 and @3 as well as an instruction §[ . . . ].

The instruction §[ . . . ] returns to the value of the expression situated between the square brackets.

It will be noted also that the code indicated in lines 10 and 11 comprises variables whose name is formed by a string of characters comprising the predetermined character $ (here the variables “$FLODA(1)” and “$FLOD(4)”), indicating that these variables are instanciable variables.

For example, the DVD-Video code of the line 11 indicates that if the variable GPRM4 is greater than or equal to 2, then the next PGC to be executed is the one designated by the variable $FLOD(4). Here, this enables a direct jump to the PGC managing the display of the responses to the questions (i.e. in this case the one managing the resource illustrated in FIG. 2E) without going through the PGCs managing the resources illustrated in FIGS. 2B to 2D: these PGCs consist in asking a question and waiting for a response to this question from the user. Thus, in one learning mode of the DVD-Video disc, it is possible to consult solely the responses to the questions.

The DVD-Video code of line 14 indicates that the following PGC to be executed is the PGC designated by the variable $FLOD(1), i.e. the one managing the picture of FIG. 2B.

The opening marker <SubFlow> (line 16) and the closing marker </SubFlow> (line 22) encloses the definition of a flow of sub-pictures.

The attribute value “Button” for the attribute “Type” of the marker <Code> of the line 17 indicates that the code defined in line 18 must only be executed when a predetermined button of the remote control is pressed. Each code line corresponds to a predetermined button. Thus, here, the first code line is executed when the first button is pressed. It would also have been possible to add a second line executed when the second button is pressed, and so and so forth.

The DVD-Video code of the line 18 indicates that there is a direct jump to the end of the PGC if one of the buttons is pressed. This shortens the execution of this PGC and makes it possible to pass more rapidly to the rest of the operation.

The marker <SubPicture> (line 21) is used to define the sub-picture of this flow. Here, the value “RemoteS” of the attribute “Template” is the value “0” of the attribute “Instance” and indicates that the sub-picture used here corresponds to the instance number 0 of the model called “RemoteS”. This sub-picture model is defined by means of XML markers and may include one or more values of instanciable attributes similarly to what was described for this model of PGC.

The marker <Highlight> (line 22) and the values of the attributes “Template” and “Instance” enable the definition of a highlight. Here, the values of attributes “RemoteS” and “0” indicate that this highlight corresponds to the instance number 0 of the highlighting model called “RemoteS”.

The models of sub-pictures and highlight “RemoteS” are built by means of XML markers defined specifically for sub-pictures and highlight models. The construction of the model “RemoteS” is similar to that described for the PGC model so that the detailed description of this model “RemoteS” is omitted.

Here, four PGC models are defined, respectively corresponding to the resources illustrated in FIGS. 2B to 2E. Each of these PGC model definitions is bounded by markers <Flow> and </Flow>. The definition of these other PGC models is done similarly to what has been described here above. Hence, to simplify FIG. 4, in line 24, the definition of the other four PGCs is omitted. This omission is indicated in line 24 by three dots.

The working of the device 2 shall now be described in the particular case of a DVD-Video disc herein called a traffic code DVD.

The traffic code DVD is designed to help users to prepare for the written part of the test for the driver's license in France.

The traffic code DVD is used to display series of 40 questions on the traffic code to which the user must respond in selecting the buttons A to D by means of his remote control unit.

More specifically, using a main menu, the user can choose between at least two modes: a practice or examination mode and a learning mode.

In each of these working modes, the browsing between the different pieces of information to be displayed is the same for each question.

For example, in practice mode, the DVD player displays first of all the picture of FIG. 2A. During the display of the picture of FIG. 2A, the audio resource associated with the FIG. 2A is played by the DVD player. When the DVD player has finished playing the audio resource, the picture of FIG. 2B is automatically presented during a period of time proportional to the number of responses that must be given by the user.

Then, the picture of FIG. 2C is displayed for a predetermined time, for example 3 seconds, and then the picture of FIG. 2D is displayed during a predetermined time, for example 3 seconds.

During the display of the pictures of FIGS. 2B to 2D, the user, using his remote control unit, can successively select two buttons chosen from among the buttons A to D to respond to the questions Q1 and Q2.

The selection of a first button commands the display of the sub-picture indicating the button selected. This sub-picture is displayed in the frame 54. Then, the user selects a second button to respond to the question Q2. The sub-picture displayed in the frame 54 is then replaced by another sub-picture containing the two letters corresponding to the two buttons selected by the user.

FIG. 5 shows the picture displayed after the user has selected the buttons A and C.

After having displayed the picture of FIG. 5, the DVD player automatically displays the next question.

In learning mode, for each question, the DVD player displays the picture of FIG. 2E. In this picture, the exact responses to the questions are highlighted. At the same time as the picture of FIG. 2E is displayed, the DVD player plays an audio resource corresponding to the reading of the exact responses.

As will be understood, the browsing structure for the traffic code DVD is particularly complex. In particular, the portions of the structure of the traffic code DVD corresponding to each of the questions are repeated as many times as there are questions.

The method of authoring this DVD-Video disc shall now be described with reference to FIG. 6.

Initially, in a step 100, the different audio, video, picture and sub-picture resources needed to create the traffic code DVD are created and then recorded in the memory 40 as resources 42.

Then, in a step 102, the Scenarist software is used to create a skeleton of the structure of the DVD-Video disc. This skeleton comprises all the portions of the structure of the traffic code DVD that are repetitive. For example, this skeleton will comprise the definition of the introduction part preceding the display of the main menu, the definition of a main menu enabling the choice of one of the modes of operation of the traffic code DVD.

Once the skeleton has been created, in a step 104, the module 34 exports this skeleton into a text file comprising instructions that are readable and directly understandable by a human being. The format of this text file is, for example, proper to the Scenarist software.

In a step 106, the data base 46 is created. For example, this data base comprises a table called “Series” defining 41 fields. The first field contains an identifier of a series of 40 questions. This identifier will, for example, have the form S##, where each symbol # represents a digit ranging from 0 to 9. The other fields are numbered 1 to 40 and are designed to contain the responses respectively to the questions 1 to 40. Here the answer to a question takes the form of a string of characters comprising one or more of the letters chosen from the set {A, B, C, D}.

Then, in a step 108, a model of the structure portion of the traffic code DVD corresponding to a question is created. More specifically, during an operation 110, using a write module 26, the structure of the traffic code DVD corresponding to only one question is written in using the low-level mnemonics defined in the Scenarist software program.

Then, in an operation 112, the module 34 exports the structure thus defined into a file having the same format as the one obtained during the step 104.

In an operation 114, the sub-module 28 automatically converts the script exported during the operation 112 into a model of a video structure portion using the XML markers defined with reference to FIG. 4. To this end, at least one of the values of the exported script is replaced by an instanciable attribute value. Here, the conversion operation 114 results in the obtaining the model for which one extract is shown in FIG. 4.

The operations 110 to 114 are reiterated for each repetitive portion of the structure of the DVD-Video disc so as to obtain a model for each of these portions.

It will be noted that during the step 108, the programmer defines precisely the organization and content of the model of a structure portion that he creates. In particular, he may choose explicitly between different possible organizations of this model of a structure portion. For example, rather than defining a PGC for each of the resources illustrated in FIGS. 2A to 2E, the programmer could have chosen to define only one PGC per question containing references to the five resources illustrated in FIGS. 2A to 2E.

Then, the module 22 goes to a step 116 of automatic instantiation of the model created during the step 108 and then to a step 117 of automatic resolution of links. To this end, the module 22 executes a script. FIG. 7 shows an extract of the listing of this written script in a programming language interpretable by the software program “Angel Script” available on the Internet site www.angelcode.com. The line numbers are shown to the left of FIG. 7. The lines 1 to 24 execute the instantiation step 116 and correspond to an implementation of the module 22, while the link resolution step 117 is performed at the line 25.

Since this script is written in a known programming language, only the lines requiring particular explanations shall be described here.

Before line 1, the variable “numserie” is initialized with the number of a series of questions. For example, here the number is “01”.

Then, between the lines 2 and 24, the script builds 40 instances of the model of FIG. 4.

The lines 4 to 6 convert the question number i into a two-character string. For example, during the first execution of the loop, the number of the question is “01”.

The line 7 combined with the line 1 enables the building of the SQL (Structure Queries Language) query making it possible to obtain the response to the question number i in interrogating the data base 46.

The lines 8 and 9 activate the execution of the SQL query and the storage of the response to the question number i in the variable “sqlres”.

The lines 10 to 18 convert the response stored in the variable “sqlres” into a digital value stored in a variable “res”.

Then, the lines 19 to 21 replace the values of attributes @1, @2 and @3 respectively by the values of the variables i−1, “res” and “in (sqlres.Len( ))”. “Sqlres.Len( )” computes the length of the string of characters forming the response. The function “in” converts this character string length into a integer. Thus the value of attribute @3 is replaced by a value proportional to the number of responses to be given to the question.

At the line 22, the function “Build_Card” builds the number i of the model. This function accepts four parameters. The first parameter whose value here is “MaxiCard” designates the name of the model to be used. This model name must correspond to the value of the attribute “TemplateName” in the marker <Card>. Then, the parameters i and ““S”+Numserie” correspond respectively to the values designed to replace the character strings @J and @T.

Thus, for the first instance built, the value of attributes “@T_@J_” is replaced by the value “S01_{—}01”.

At the line 23, the created instance is added to the group of created instances.

Once the set of instances of the model has been created, at the line 25, a function “Scp_Build( )” performs the step 117. This function “Scp_Build( )” corresponds to the software implementation of the module 23.

At the step 117, the value of the instanciable variables of each instance of the model is defined in taking account of the set of created instances. For example, the value of the instanciable variables is defined as a function of the identifier assigned to each of the instances, i.e. in this case the value of the attribute “Name” of the marker <Card> or again of the number of instances created.

For example, it is during the step 118 that a string of characters $FLOD(4) is replaced by the address pertaining to the definition of the PGC managing the resource illustrated in FIG. 2E.

Once the link resolution is terminated, the function Scp_Build( ) inserts also the instances created in the file exported at the step 104.

On this occasion, each instance is added to the file exported in text form using the mnemonics defined by the software program Scenarist so that, at the step 118, the module 34 can import this modified file.

Once the importing of the file has been done, the sub-module 26 can be used to complete the authoring of the DVD-Video disc in a step 120.

Once the structure and code of the entire DVD-Video disc has been prepared, in a step 122, the picture of the DVD-Video disc is built. In this step 122, the compiler 24 compiles the prepared project and especially the instances created in the step 116.

Finally, in a step 124, the picture of the DVD-Video disc is burned into a DVD disk, for example.

Many other embodiments of the device and of the method of FIG. 6 are possible. For example, the sub-module 28 is replaced, in a variant, by a text editor enabling the programmer to manually convert the example of a structure of a question of the traffic code DVD into a model of questions.

The data base 46 can also be omitted. In this particular case, at the creation of each instance, the module 22 is adapted to acquire each instanciable attribute value from the programmer.

The software programs 30 and 32 are, as a variant, executed by remote electronic computers connected to one another by means of a long-distance information transmission network.

Here, the values of instanciable attributes have been described as being placed within the opening marker. As a variant, these values of instanciable attributes are placed between the opening marker and the corresponding closing marker.

It will be noted that the resources 42 are created independently of the instances. This enables the optimizing of the management of the resources 42 enabling, for example, several instances to refer to the same resource.

1. Method for authoring a DVD-Video disc, wherein the method comprises:
a) a step for creating a model, written solely in an SGML (Standard Generalized Markup Language), for a DVD-Video structure portion, this model comprising:
markers of the SGML defining at least one PGC (Program Chain) and elements of this PGC, the interleaving of these markers with each other defining a hierarchically established organization of the elements of the PGC,
at least one instanciable attribute value constituted by a string of characters in place of an attribute value for a marker, this instanciable attribute value containing at least one predetermined character enabling the identification of this string of characters as being an instanciable attribute value,
b) a step of instantiation of the model during which each instanciable attribute value is automatically replaced by a given value to obtain an instance of the model, and
c) a step of generation of a picture of the DVD-Video disc capable of being read by a DVD-Video player, each instance being compiled in this step.

2. Method according to claim 1, wherein the model contains a DVD-Video code between the markers, at least one portion of this code being replaced by an instanciable variable constituted by a string of characters containing at least one predetermined character enabling the identification of this string of characters as being an instanciable variable and wherein between the steps b) and c), the method comprises a step of resolution of links during which the value of each instanciable variable is automatically defined as a function of the instances created.

3. Method according to claim 1, wherein the step a) comprises:
an operation for the writing, by means of low-level mnemonics and values of attributes, of a DVD-Video structure portion defining one or more PGCs, and
a step of automatic conversion of this structure portion into a DVD-Video structure model in replacing at least one attribute value by an instanciable attribute value.

4. Method according to claim 1, characterized wherein, during the step b), the given values are obtained automatically from a data base.

5. Computer program wherein it comprises instructions for the implementation of a method for authoring a DVD-Video compliant with claim 1, when the instructions are executed by an electronic computer.

6. Information-recording medium wherein it comprises instructions for the implementation of a method for authoring a DVD-Video compliant with claim 1, when the instructions are executed, by an electronic computer.

7. Device for the creation of a DVD-Video disc comprising:
a module for creating a model, written solely in an SGML, of a DVD-Video structure portion, this module comprising:
markers of an SGML (Standard Generalized Markup Language) defining at least one PGC (Program Chain) and elements of this PGC, the interleaving of these markers with each other defining a hierarchically established organization of the elements of the PGC,
at least one instanciable attribute value constituted by a string of characters in place of an attribute value for a marker, this instanciable attribute value containing at least one predetermined character enabling the identification of this string of characters as being an instanciable attribute value,
a module for instantiating the created model capable of automatically replacing each instanciable attribute value of the module by a given value to obtain an instance of the model, and
a compiler capable of compiling each instance of the model to generate a picture of the DVD-Video disc readable by a DVD-Video disc.

8. Device according to claim 7, wherein the creation module is capable of creating a model comprising a DVD-Video code between the markers, at least one portion of this code being replaced by an instanciable variable constituted by a string of characters containing at least one predetermined character enabling the identification of this string of characters as being an instanciable variable, and wherein it comprises a module for the resolution of links capable of automatically defining the value of each instanciable variable as a function of the instances created.

9. Device according to claim 7, wherein the creation module comprises:
a sub-module for writing a DVD-Video structure portion defining one or more PGCs by means of low-level mnemonics and values of attributes, and
a conversion sub-module capable of automatically converting the DVD-Video structure portion written by means of the write sub-module into a DVD-Video structure model in replacing at least one attribute value by an instanciable attribute value.

10. Device according to claim 7, wherein the instantiation module is capable of automatically obtaining the values given to the instanciable attribute values from a data base.

11. Module for instantiation of a model of a DVD-Video structure portion capable of being implemented in a device according to claim 7, wherein the instantiation model is capable of automatically replacing each instanciable attribute value of the module by a given value to obtain an instance of the model.
